(19) United States
(12) Patent Application Publication
(10) Pub. No.: US 2018/0329769 A1
(43) Pub. Date: Nov. 15, 2018

(54) METHOD, COMPUTER READABLE STORAGE MEDIUM AND ELECTRONIC DEVICE FOR DETECTING ANOMALIES IN TIME SERIES

(71) Applicant: NEUSOFT CORPORATION, Shenyang (CN)

(72) Inventors: Muxin SUN, Shenyang (CN); Zifan SHI, Shenyang (CN); Li XU, Shenyang (CN); Xia ZHANG, Shenyang (CN)

(73) Assignee: NEUSOFT CORPORATION, Shenyang (CN)

(21) Appl. No.: 15/783,522

(22) Filed: Oct. 13, 2017

(30) Foreign Application Priority Data
May 15, 2017 (CN) 201710340508.X

(51) Int. Cl. G06F 11/07

(52) U.S. Cl. CPC G06F 11/079; G06F 11/0772; G06F 11/0751

(57) ABSTRACT

A method for detecting anomalies in time series, a computer readable storage medium and an electronic device. An example method comprises: obtaining current metrical data; obtaining a time series set corresponding to the current metrical data; for each time series in the time series set, judging whether a memory nerve cell used for recording the time series exists; activating the memory nerve cell when the existence of the memory nerve cell is judged; allocating a memory nerve cell to the time series so as to record the time series when the absence of the memory nerve cell is judged, and activating the allocated memory nerve cell; and determining whether the current metrical data is abnormal at least according to the activated memory nerve cells.

### FIELD OF THE TECHNICAL

The present disclosure relates to the field of anomaly detection, and in particular to a method, computer readable storage medium and electronic device for detecting anomalies in time series.

### BACKGROUND

Data anomaly detection technology plays an important role in various industries, for example, discovering small changes of heartbeat, blood pressure, breath and other indexes of patients, positioning suspicious operation behaviors of critical system administrators, exploring abnormal stock price changes in the stock market, detecting the instability of CPUs, memories, HTTP response time and other key indexes of application systems, and so on. The implementation of these functions is inseparable from a fast and accurate method for detecting anomalies in time series.

However, with the rapid development of the computer software technology, the implementation of monitoring systems, especially anomaly monitoring systems becomes more and more difficult. The main reasons are as follows: (1) as the scale of monitored applications is increasing, the indexes that are being monitored are more and more; (2) the complexity of the monitoring systems is getting higher, and the rules of the index changes are more and more difficult to explore; and (3) the traditional time series analysis model for anomaly detection is becoming less adaptable to the highly complex index changes, which not only leads to the increase of the computational complexity, but also affects the anomaly detection effect to a certain extent. Therefore, it is of great importance to find a method for detecting anomaly which can adapt to metrical data in a massive scale and with complex changes so as to improve the accuracy of data anomaly detection.

### SUMMARY

The objective of the present disclosure is to provide a method, a computer readable storage medium and an electronic device for detecting anomalies in time series, in order to effectively improve the accuracy of data anomaly detection.

To achieve the above-mentioned objective, the present disclosure provides a method for detecting anomalies in time series, comprising:

obtaining current metrical data, wherein the current metrical data and historically obtained metrical data of the same type form a target time series;

obtaining a time series set corresponding to the current metrical data, wherein the time series set comprises at least one time series formed according to continuous metrical data from the n^{th} metrical data prior to the current metrical data to the current metrical data in the target time series, and n is a natural number;

for each time series in the time series set, judging whether a memory nerve cell used for recording the time series exists;

when the existence of the memory nerve cell is judged, activating the memory nerve cell;

when the absence of the memory nerve cell is judged, allocating a memory nerve cell to the time series so as to record the time series and activating the allocated memory nerve cell; and

determining whether the current metrical data is abnormal at least according to the activated memory nerve cells.

The present disclosure further provides a computer readable storage medium with a computer program stored thereon, wherein the program realizes the steps of the above-mentioned method for detecting anomalies in time series when being executed by a processor.

The present disclosure further provides an electronic device, comprising:

the computer readable storage medium provided by the present disclosure; and

one or more processors, used for executing the program in the computer readable storage medium.

In the above-mentioned technical solutions, the anomaly monitoring system records each time series in the time series set corresponding to the current metrical data through the memory nerve cell to form a memory nerve cell layer similar to a cerebral cortical nerve cell, and detects the anomaly of the current metrical data through the memory nerve cell layer. As a time series memory search mode is adopted in the anomaly detection, there is no need to mathematically fit the metrical data, therefore the anomaly monitoring system supports the anomaly detection of non-continuous metrical data to which the time series cannot be predicted, for example, it can be applied to the anomaly detection during magnetic disk read-write. Therefore, the adaptability of the anomaly monitoring system to different types of metrical data and complexly changing metrical data is higher. In addition, as the anomaly monitoring system can gradually reinforce the learning ability and the judging ability according to the gradually obtained metrical data, it does not need to learn large-scale historical data in advance, and thus the problem of cold start can be solved. Moreover, the larger the scale of the obtained metrical data is, the higher the learning ability and the judging ability of the anomaly monitoring system are, and the higher the accuracy of anomaly detection is.

Other features and advantages of the present disclosure will be described in detail in the following detailed description.

### BRIEF DESCRIPTION OF THE DRAWINGS

The drawings are intended to provide a further understanding of the present disclosure, constitute a part of the specification, and explain the present disclosure together with the following specific implementations, but do not constitute limitation to the present disclosure.

In the drawings:

FIG. 1A is a flowchart of a method for detecting anomalies in time series shown according to an exemplary embodiment.

FIG. 1B is a flowchart of a method for detecting anomalies in time series shown according to another exemplary embodiment.

FIG. 1C is a flowchart of a step of determining whether current metrical data is abnormal at least according to an activated memory nerve cells shown according to an exemplary embodiment.

FIG. 1D is a flowchart of a method for detecting anomalies in time series shown according to another exemplary embodiment.

FIG. 1E is a flowchart of a method for detecting anomalies in time series shown according to another exemplary embodiment.

FIG. 2A is a curve chart of metrical data obtained by an anomaly monitoring system within a preset time period shown according to an exemplary embodiment.

FIG. 2B and FIG. 2C are schematic diagrams of a process of encoding a compression value to obtain encoded data corresponding to current metrical data shown according to an exemplary embodiment.

FIG. 3A and FIG. 3B are schematic diagrams of a process of allocating a memory nerve cell to a time series so as to record the time series and activating the allocated memory nerve cell shown according to an exemplary embodiment.

FIG. 3C and FIG. 3D are schematic diagrams of a process of activating a memory nerve cell used for recording a time series shown according to an exemplary embodiment.

FIG. 4 is a schematic diagram of recording a time series in a hash storage mode shown according to an exemplary embodiment.

FIG. 5 is a block diagram of an apparatus for detecting anomalies in time series shown according to an exemplary embodiment.

FIG. 6 is a block diagram of an apparatus for detecting anomalies in time series shown according to another exemplary embodiment.

FIG. 7 is a block diagram of an apparatus for detecting anomalies in time series shown according to another exemplary embodiment.

FIG. 8A is a block diagram of an apparatus for detecting anomalies in time series shown according to another exemplary embodiment.

FIG. 8B is a block diagram of an apparatus for detecting anomalies in time series shown according to another exemplary embodiment.

FIG. 9 is a block diagram of an electronic device shown according to an exemplary embodiment.

FIG. 10 is a block diagram of an electronic device shown according to another exemplary embodiment.

### DETAILED DESCRIPTION OF THE EMBODIMENTS

Specific implementations of the present disclosure will be described below in detail with reference to the drawings. It should be understood that the specific implementations described herein are for the purpose of illustrating and explaining the present disclosure only and are not intended to limit the present disclosure.

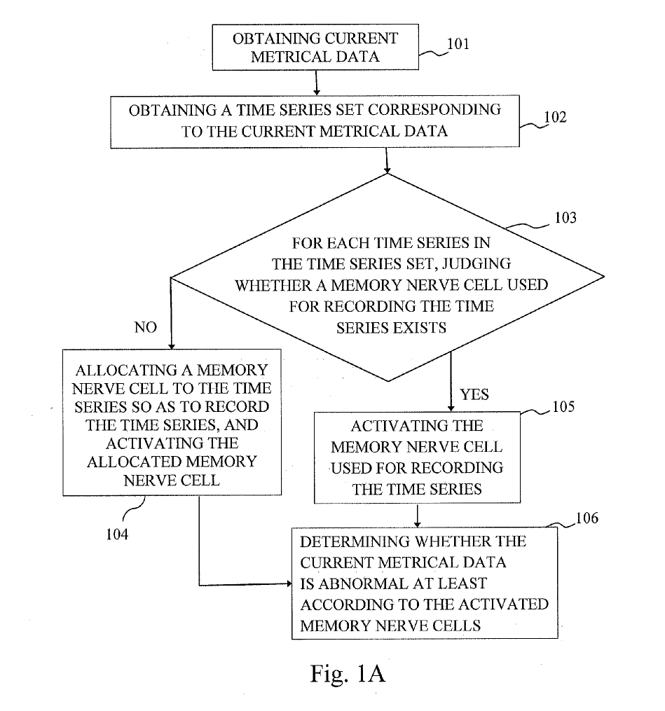

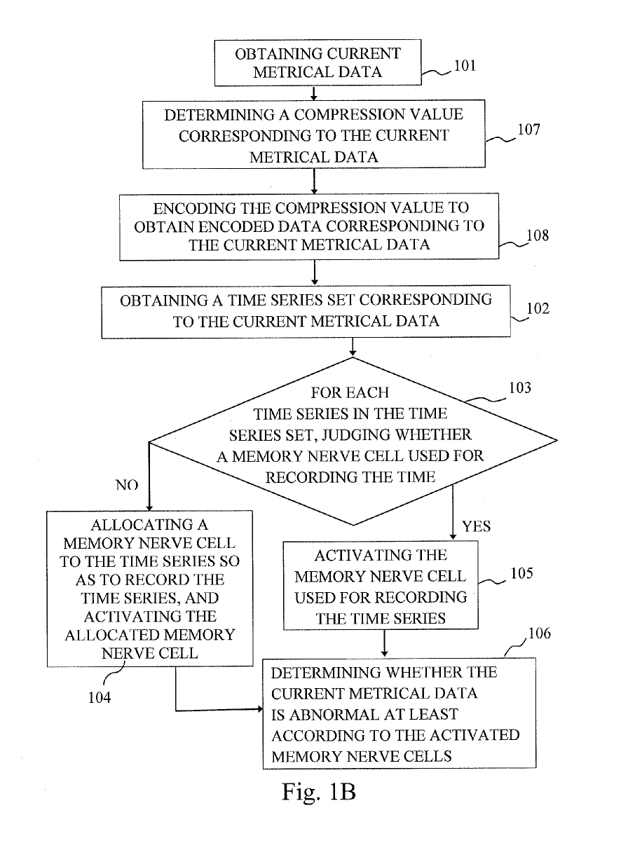

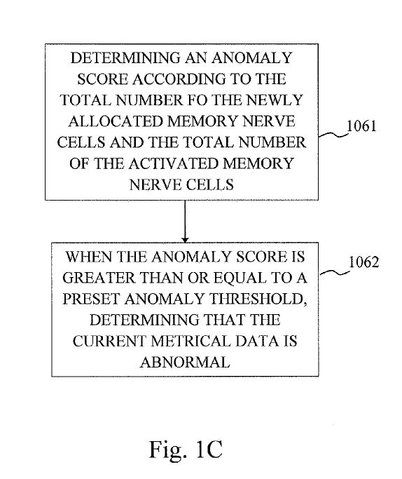

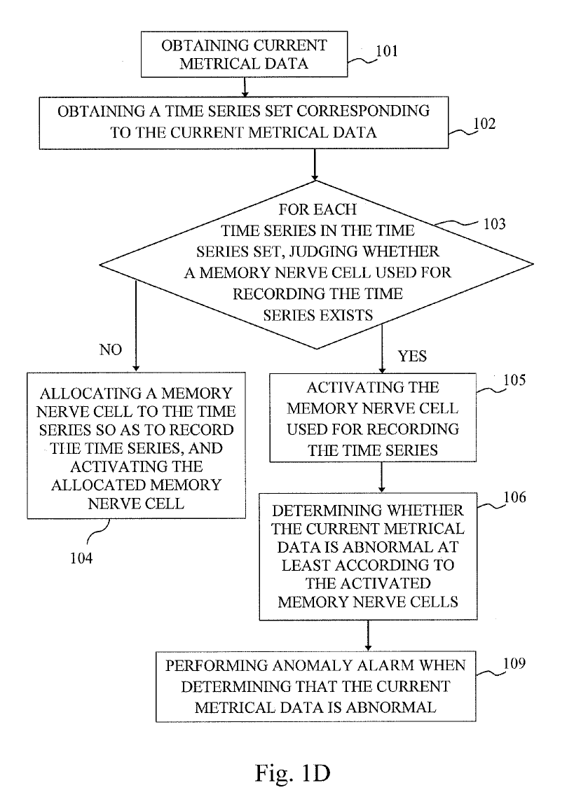

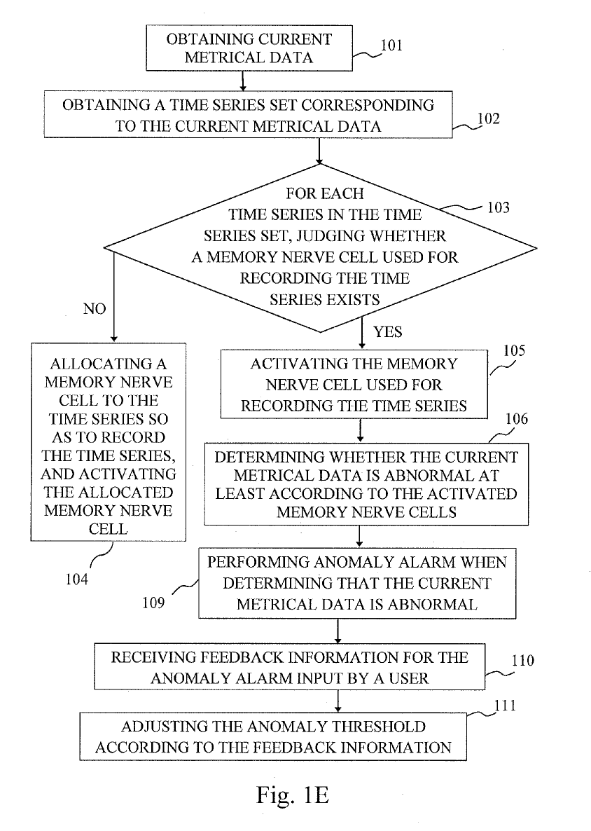

FIG. 1A is a flowchart of a method for detecting anomalies in time series shown according to an exemplary embodiment. As shown in FIG. 1A, the method can comprise the following steps:

In step 101, current metrical data is obtained.

In the present disclosure, the method for detecting anomalies in time series can be applied to an anomaly monitoring system. The anomaly monitoring system can obtain the current metrical data according to a fixed period, and can also obtain the current metrical data when receiving an instruction of obtaining the current metrical data from a system administrator.

In addition, the current metrical data can form a target time series together with one or more metrical data of the same type historically obtained by the anomaly monitoring system, wherein the metrical data of the same type historically obtained by the anomaly monitoring system can be stored in a database of the system, the anomaly monitoring system extracts historical metrical data of the same type as the current metrical data from the database after obtaining the current metrical data and adds the current metrical data to the extracted metrical data of the same type to form the target time series. For example, the current metrical data is 175, the metrical data of the same type historically obtained by the anomaly monitoring system are 63, 51 and 144, after the current metrical data 175 is added to the metrical data of the same type, the target time series 63→51→144→175 is formed. It can be easily understood that each metrical data in the target time series is ordered according to the collection time from early to late.

In step 102, a time series set corresponding to the current metrical data is obtained.

In the present disclosure, the time series set can comprise at least one time series formed according to continuous metrical data from the n^{th} metrical data prior to the current metrical data to the current metrical data in the target time series, wherein n is a natural number. Exemplarily, n=2, then the time series set can comprise two time series formed by continuous metrical data from the second metrical data prior to the current metrical data to the current metrical data in the target time series. For example, the current metrical data is 175, the target time series is 63→51→144→175, the second metrical data prior to the current metrical data is 51, and the two time series formed according to continuous metrical data from the second metrical data 51 prior to the current metrical data to the current metrical data in the target time series comprise: 51→144→175 and 144→175, and then the time series set corresponding to the current metrical data is {51→144→175, 144→175}.

In order to enhance the robustness of the method for detecting anomalies in time series, each metrical data in the time series set can be encoded. In this way, each time series in the time series set is a sequence composed of each encoded data respectively corresponding to each metrical data forming the time series. As shown in FIG. 1B, the encoded data corresponding to the metrical data can be obtained in the following manner:

In step 107, a compression value corresponding to the current metrical data is determined.

Exemplarily, the compression value corresponding to the current metrical data can be determined by the following formula (1):

$${v}^{′} = max ( ⌊ \frac{v - {v}_{min}}{{v}_{max} - {v}_{min}} \times M ⌋ , 0 ) \qquad ( 1 )$$

wherein, v′ represents the compression value, v represents the current metrical data; vₘᵢₙ represents the minimum value in the target time series; vₘₐₓ represents the maximum value in the target time series; and M represents the number of parts into which the data interval between the minimum value and the maximum value is equally divided.

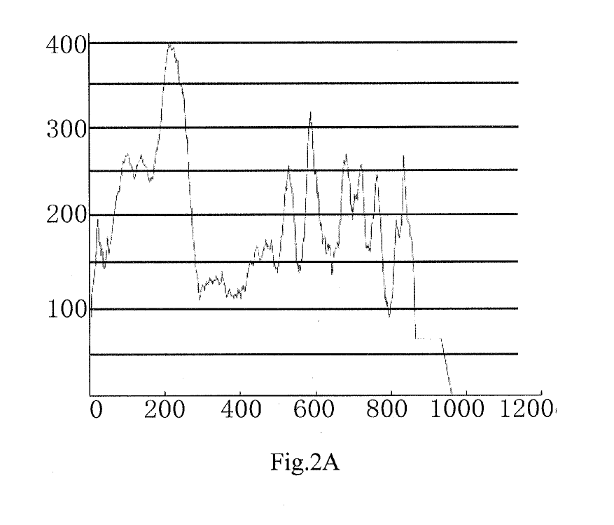

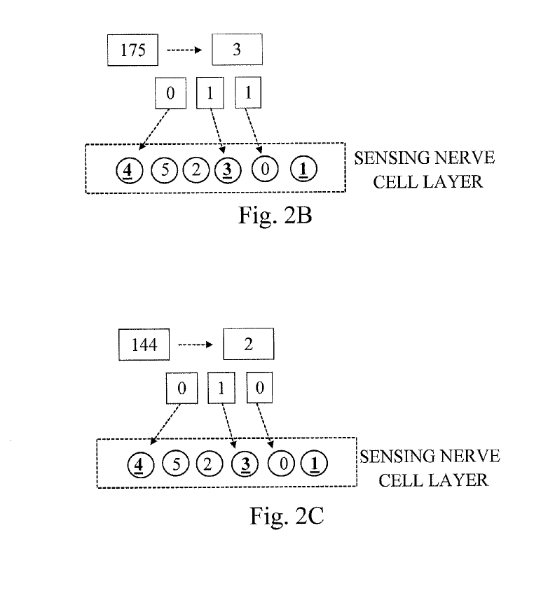

The value of M is determined by the noise distribution, the size of the storage space, the computational efficiency and the like. Exemplarily, M=8, namely the data interval between the maximum value and the minimum value in the target time series is equally divided into 8 parts. FIG. 2A shows a plot (vertical coordinates represent the value of the metrical data and horizontal ordinates represent sequence numbers corresponding to the metrical data) of the metrical data obtained by the anomaly monitoring system. As shown in FIG. 2A, the data interval between the maximum value and the minimum value is equally divided into 8 parts, wherein the 0th equal interval is 0-50, the first equal interval is 50-100, the second equal interval is 100-150, the third equal interval is 150-200, . . . , and the seventh equal interval is 350-400. For example, the current metrical data is 175, it can be obtained according to the above formula (1) that the compression value is 3, and in FIG. 2A, 175 is located within the third equal interval.

In step 108, the compression value is encoded to obtain the encoded data corresponding to the current metrical data.

In one implementation, the compression value can be encoded in such a manner that a binary form corresponds to a nerve cell. Specifically, the compression value can be converted into the binary form, and the compression value in the binary form is mapped to a corresponding sensing nerve cell from low bit to high bit to obtain the encoded data corresponding to the current metrical data.

Exemplarily, as shown in FIG. 2B, a sensing nerve cell layer comprises 6 mapped sensing nerve cells, and every two sensing nerve cells form a group. Specifically, the sensing nerve cell layer comprises a 0^{th} sensing nerve cell, a first sensing nerve cell, a second sensing nerve cell, a third sensing nerve cell, a fourth sensing nerve cell and a fifth sensing nerve cell, wherein the 6 sensing nerve cells are equally divided into three groups, namely the 0^{th} sensing nerve cell and the first sensing nerve cell form a group, the second sensing nerve cell and the third sensing nerve cell form a group, and the fourth sensing nerve cell and the fifth sensing nerve cell form a group. If the binary value is 0, the binary value is mapped to the sensing nerve cell having a smaller serial number in the group of sensing nerve cells, and on the contrary, if the binary value is 1, the binary value is mapped to the sensing nerve cell having a larger serial number in the group of sensing nerve cells. For example, as shown in FIG. 2B, the binary form of the compression value 3 of the current metrical data 175 is 011 and is sequentially 1, 1 and 0 from low bit to high bit, wherein the first bit 1 is mapped to the sensing nerve cell having a larger serial number in the 0^{th} sensing nerve cell and the first sensing nerve cell, i.e. the first bit 1 is mapped to the first sensing nerve cell, similarly, the second bit 1 is mapped to the third sensing nerve cell, and the third bit 0 is mapped to the fourth sensing nerve cell, namely, the compression value 3 is respectively mapped to the first sensing nerve cell, the third sensing nerve cell and the fourth sensing nerve cell from low bit to high bit, that is, the encoded data corresponding to the current metrical data 175 is 134.

As another example, as shown in FIG. 2C, the binary form of the compression value 2 of the current metrical data 144 is 010 and is sequentially 0, 1 and 0 from low bit to high bit, wherein the first bit 0 is mapped to the sensing nerve cell having the smaller serial number in the 0th sensing nerve cell and the first sensing nerve cell, i.e. the first bit 0 is mapped to the 0^{th} sensing nerve cell, similarly, the second bit 1 is mapped to the third sensing nerve cell, and the third bit 0 is mapped to the fourth sensing nerve cell, namely, the compression value 2 is respectively mapped to the 0^{th} sensing nerve cell, the third sensing nerve cell and the fourth sensing nerve cell from low bit to high bit, that is, the encoded data corresponding to the current metrical data 144 is 034.

In this way, each time series in the time series set is a sequence composed of the encoded data corresponding to the metrical data forming the time series. Exemplarily, the time series 51→144→175 can be correspondingly expressed as 124→034→134, and the time series 144→175 can be correspondingly expressed as 034→134.

As the metrical data in the time series set are encoded, the metrical data can be mapped to the corresponding sensing nerve cells, so that the metrical data are independent from each other, and each sensing nerve cell has a certain physical sensing range. Therefore, even if the current metrical data is lost, the current metrical data can be locked to a certain physical sensing area, and thus the robustness of the method for detecting anomalies in time series is enhanced.

In step 103, for each time series in the time series set, whether a memory nerve cell used for recording the time series exists is judged.

In the present disclosure, the anomaly monitoring system can comprise a memory nerve cell layer, the memory nerve cell layer comprises a plurality of memory nerve cells used for recording the time series. After the anomaly monitoring system obtains the time series set corresponding to the current metrical data, for each time series in the time series set, the anomaly monitoring system can determine whether the current memory nerve cell layer comprises the memory nerve cell used for recording the time series by searching the memory nerve cell layer.

In one implementation, when the current memory nerve cell layer is judged to not comprise the memory nerve cell used for recording the time series, the following step 104 is executed.

In step 104, a memory nerve cell is allocated to the time series so as to record the time series, and the allocated memory nerve cell is activated.

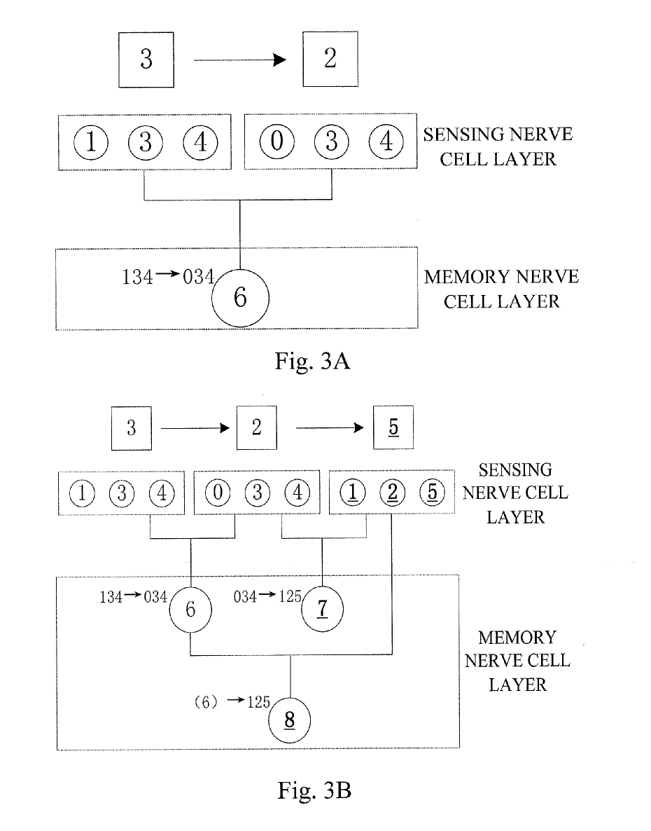

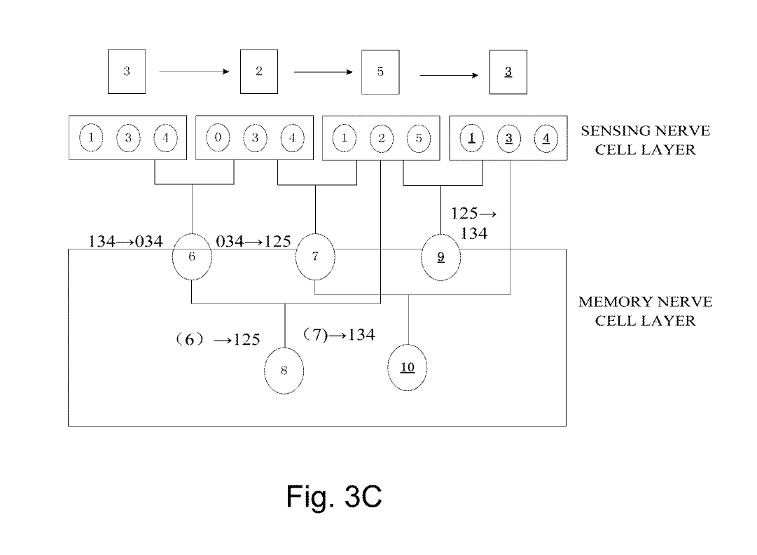

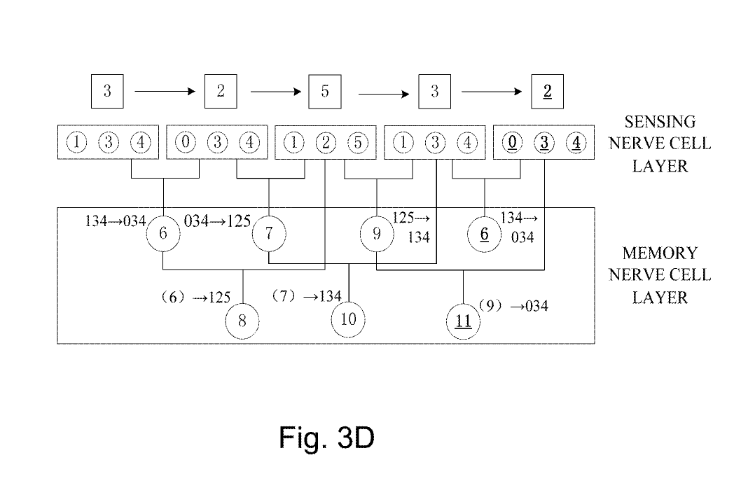

Exemplarily, as shown in FIG. 3A, the current memory nerve cell layer comprises a sixth memory nerve cell used for recording the time series 134→034. For example, as shown in FIG. 3B, the compression value of the current metrical data is 5, the encoded data corresponding to the current metrical data is 125, and then the time series set corresponding to the current metrical data is {134→034→125, 034→125}. It can be determined that the current memory nerve cell layer does not comprise the memory nerve cell used for recording the time series 134→034→125 and memory nerve cell used for recording the time series 034→125 by searching the current memory nerve cell layer, at this time, the anomaly monitoring system can respectively allocate a memory nerve cell to the time series 134→034→125 and the time series 034→125 to record the corresponding time series, and activate the two allocated memory nerve cells. In FIG. 3B, a seventh memory nerve cell is newly allocated to record the time series 034→125, an eighth memory nerve cell is newly allocated to record the time series 134→034→125, and the seventh memory nerve cell and the eighth memory nerve cell are activated. In addition, as the sixth memory nerve cell records the time series 134→034, the time series 134→034→125 can be expressed as (6)→125.

In another implementation, when it is determined that the current memory nerve cell layer comprises the memory nerve cell used for recording the time series, the following step 105 is executed.

In step 105, the memory nerve cell used for recording the time series is activated.

Exemplarily, as shown in FIG. 3B, the current memory nerve cell layer comprises 3 memory nerve cells used for recording the time series, namely, the sixth memory nerve cell, the seventh memory nerve cell and the eighth memory nerve cell. For example, as shown in FIG. 3C, the compression value of the current metrical data is 3, the encoded data corresponding to the current metrical data is 134, it is assumed that the time series set can comprise the two time series formed by continuous metrical data from the second metrical data prior to the current metrical data to the current metrical data in the target time series, and then the time series set corresponding to the current metrical data comprises a time series 125→134 and a time series 034→125→134. It can be determined that the current memory nerve cell layer does not comprise the memory nerve cell used for recording the time series 125→134 and the memory nerve cell used for recording the time series 034→125→134 by searching the current memory nerve cell layer, at this time, the anomaly monitoring system respectively allocates a memory nerve cell to the time series 125→134 and the time series 034→125→134 to record the corresponding time series, and activate the two allocated memory nerve cells. In FIG. 3C, a ninth memory nerve cell is newly allocated to record the time series 125→134, a tenth memory nerve cell is newly allocated to record the time series 034→125→134, and the ninth memory nerve cell and the tenth memory nerve cell are activated. In addition, as the seventh memory nerve cell records the time series 034→125, the time series 034→125→134 can be expressed as (7)→134.

As another example, the current memory nerve cell layer is as shown in FIG. 3C, the compression value of the current metrical data is 2, the encoded data corresponding to the current metrical data is 034, it is assumed that the time series set comprises the two time series formed by continuous metrical data from the second metrical data prior to the current metrical data to the current metrical data in the target time series, and then the time series set corresponding to the current metrical data comprises the time series 134→034 and a time series 125→134→034. It can be determined that the current memory nerve cell layer comprises the sixth memory nerve cell used for recording the time series 134→034 by searching the current memory nerve cell layer, and at this time, as shown in FIG. 3D, the anomaly monitoring system activates the sixth memory nerve cell used for recording the time series 134→125. In addition, it can also be determined that the current memory nerve cell layer does not comprise a memory nerve cell used for recording the time series 125→134→034 by searching the current memory nerve cell layer, and at this time, the anomaly monitoring system allocates a memory nerve cell to the time series 125→134→034 to record the time series, and activates the allocated memory nerve cell. As shown in FIG. 3D, an eleventh memory nerve cell is newly allocated to record the time series 125→134→034, and the eleventh memory nerve cell is activated. Similarly, as the ninth memory nerve cell records the time series 125→134, the time series 125→134→034 can be expressed as (9)→034.

In addition, with the passage of time, the scale of the same type of metrical data increases gradually, and the time series recorded by the memory nerve cells become more and more. As the storage capacity of the anomaly monitoring system is limited, in a preferred implementation, a forgetting mechanism can be set to forget some time series. Exemplarily, some time series can be forgotten by limiting the total number of activated memory nerve cells. In one implementation, when the absence of the memory nerve cell used for recording the time series is judged, and when the total number of the activated memory nerve cells is smaller than a predetermined number, a new memory nerve cell is allocated to the time series so as to record the time series, and the allocated new memory nerve cell is activated.

In another implementation, when the absence of the memory nerve cell used for recording the time series is judged, and when the total number of the activated memory nerve cells reaches the predetermined number, a memory nerve cell having the least activation time in the activated memory nerve cells is reallocated to the time series so as to record the time series, and the reallocated memory nerve cell is activated. The less the occurrence time of the time series is, the less the occurrence time of the metrical data corresponding to the time series is, the smaller the anomaly possibility of the metrical data is, and correspondingly, the less the activation time of the memory nerve cell corresponding to the time series is. Therefore, the memory nerve cell having the least activation time is reallocated, and very little influence is generated to the accuracy of data anomaly detection.

In yet another implementation, when the absence of the memory nerve cell used for recording the time series is judged, and when the total number of the activated memory nerve cells reaches the predetermined number, the memory nerve cell that is activated at the earliest time in the activated memory nerve cells is reallocated to the time series so as to record the time series, and the reallocated memory nerve cell is activated. In this way, the storage space of the anomaly monitoring system can be saved.

The predetermined number is determined by the storage capacity of the anomaly monitoring system, and the predetermined number can be 1000, for example. The larger the value of the predetermined number is, the larger the storage space necessary for data anomaly detection is, and on the contrary, the necessary storage space is smaller. The smaller the value of the predetermined number is, the more radical the data anomaly detection of the anomaly monitoring system is, and on the contrary, the more conservative the data anomaly detection of the anomaly monitoring system is.

In addition, the time series can be recorded in a hash storage manner. Exemplarily, with respect to the sixth memory nerve cell used for recording the time series 134→034, a hash code can be generated by the encoded data 134 and the encoded data 034 in the time series 134→034 through a first hash function, wherein the hash code is an address of a storage area corresponding to the time series 134→034 in a hash table, and the storage area comprises a plurality of storage positions. For example, the first hash function can be:

h({a₁,a₂ . . . ,aₙ}→{b₁,b₂ . . . bₘ})=a₁·2¹+ . . . +aₙ·2ⁿ+b₁·2¹+ . . . +bₘ·2^{m}

wherein, {a₁, a₂ . . . , aₙ} respectively represents the values of digits (from left to right) of the encoded data corresponding to the first metrical data in the time series, and {b₁, b₂ . . . , bₘ} respectively represents the values of the digits (from left to right) of the encoded data corresponding to the second metrical data in the time series. In this way, the hash code corresponding to the time series 134→034 is h(134→034)=(1*2+3*2²+4*2³)+(0*2¹+3*2²+4*2³)=90, that is, the 134→034 is stored in a corresponding storage position of the storage area 90 in the hash table.

In addition, a corresponding hash code can also be generated by the serial number 6 of the sixth memory nerve cell through a second hash function, and the hash code corresponding to the serial number 6 and the time series 134→034 are stored in the corresponding storage position in the storage area 90 corresponding to the time series in the hash table. Exemplarily, the second hash function can be a sum of the serial number of the memory nerve cell and 2³⁰, and thus the hash code corresponding to the serial number 6 is 6+2³⁰=6+1073741824=1073741830. After the hash code corresponding to the serial number 6 is determined, the hash code corresponding to the serial number 6 and the time series 134→034 can be stored in the corresponding storage position in the storage area 90 corresponding to the time series in the hash table, that is, 1073741830: 134→034 is stored in the corresponding storage position in the storage area 90 in the hash table.

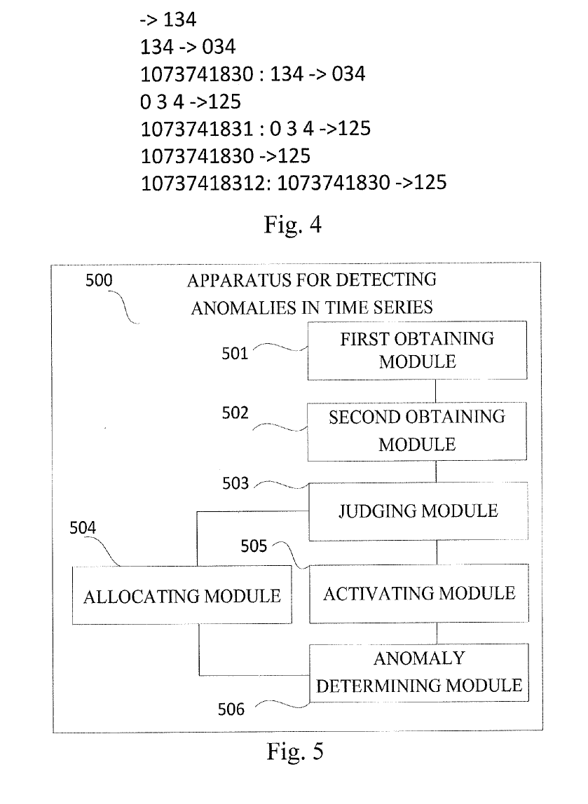

Specifically, as shown in FIG. 4, the anomaly monitoring system obtains the encoded data 134 corresponding to the first metrical data and then obtains the second metrical data of the same type, the encoded data corresponding to the second metrical data is 034, the time series set corresponding to the second metrical data comprises the time series 134→034, the time series 134→034 is recorded by the sixth memory nerve cell, the time series 134→034 and the serial number 6 of the sixth memory nerve cell corresponding to the time series are stored in a hash manner, that is, 1073741830: 134→034 is stored in the corresponding storage position in the storage area 90 corresponding to the time series 134→034 in the hash table; thereafter, the anomaly monitoring system obtains the third metrical data of the same type, the encoded data corresponding to the third metrical data is 125, the time series set corresponding to the third metrical data comprises the time series 034→125 and the time series 134→034→125 (i.e., (6)→125), the time series 034→125 is recorded by the seventh memory nerve cell, and the time series (6)→125 is recorded by the eighth memory nerve cell. When the two time series are recorded in the hash storage manner, the time series 034→125 and the serial number 7 of the seventh memory nerve cell corresponding to the time series can be stored in the hash manner, wherein the address of the storage area corresponding to the time series 034→125 in the hash table is h(034→125)=(0*2+3*2²+4*2³)+(1*2¹+2*2²+5*2³)=94, the hash code corresponding to the serial number 7 is 1073741831, that is, 1073741831: 034→125 is stored in the corresponding storage position of the storage area 94 in the hash table. Meanwhile, the time series 134→034→125 and the serial number 8 of the eighth memory nerve cell corresponding to the time series are stored in the hash manner, wherein the address of the storage area corresponding to the time series 134→034→125 (also expressed as (6)→125) in the hash table is:

h((6)→125)=h(1073741830→125)=(1*2¹+7+3*2+7*2⁵+4*2″+1*2⁷+8*2+3*2⁹)+(1*2¹+2*2²+5*2³)=4348

the hash code corresponding to the serial number 8 is 1073741832, namely, 1073741832: (6)→125 (also expressed as 1073741832: 1073741830→125) is stored in the corresponding storage position of the storage area 4348 in the hash table.

On this basis, whether the current memory nerve cell layer comprises the memory nerve cell used for recording the time series can be determined by performing hash search on the hash table. For example, when whether the memory nerve cell layer comprises the memory nerve cell used for recording the time series 134→034 is determined by performing the hash search, a hash code 90 can be generated by the encoded data 134 and the encoded data 034 in the time series 134→034 through the first hash function, the corresponding storage area is found in the hash table through the hash code 90, and then whether the contents stored in the storage area contain the time series 134→034 is judged. That is to say, when the storage contents in the storage area corresponding to the hash code 90 corresponding to the time series 134→034 in the hash table contain 134→034, it can be determined that the current memory nerve cell layer comprises the memory nerve cell used for recording the time series 134→034, and the serial number, namely the serial number 6, of the corresponding memory nerve cell can be obtained through the second hash function according to the code 1073741830 corresponding to the 134→034, and then the sixth memory nerve cell corresponding to the serial number 6 is activated; when the storage contents in the storage area corresponding to the hash code 90 corresponding to the time series 134→034 in the hash table do not contain 134→034, it can be determined that the current memory nerve cell layer does not comprise the memory nerve cell used for recording the time series 134→034, at this time, a storage position can be allocated in the storage area 90, meanwhile a memory nerve cell is allocated in the memory nerve cell layer to record the time series, and the hash code corresponding to the serial number of the memory nerve cell and the time series are stored in the newly allocated storage position in the storage area 90.

In step 106, whether the current metrical data is abnormal is determined at least according to the activated memory nerve cells.

The more the number of the newly allocated memory nerve cells is, the larger the anomaly possibility of the current metrical data is; and the more the number of the activated memory nerve cells is, the smaller the anomaly possibility of the current metrical data is. Therefore, in one implementation, whether the current metrical data is abnormal can be determined according to the total number of the newly allocated memory nerve cells and the total number of the activated memory nerve cells. As shown in FIG. 1C, the above step 106 can comprise the following steps.

In step 1061, an anomaly score is determined according to the total number of the newly allocated memory nerve cells and the total number of the activated memory nerve cells.

Exemplarily, the anomaly score can be determined through the following formula (2):

$$score = \frac{new}{active} \qquad ( 2 )$$

wherein, score represents the anomaly score; new represents the total number of the newly allocated memory nerve cells; and active represents the total number of the activated memory nerve cells.

For example, according to the situation as shown in FIG. 3C, the newly allocated memory nerve cells are the ninth memory nerve cell and the tenth memory nerve cell, the activated memory nerve cells are the ninth memory nerve cell and the tenth memory nerve cell, namely the total number new of the newly allocated memory nerve cells is 2, the total number active of the activated memory nerve cells is 2, and thus the anomaly score is 1.

As another example, according to the situation as shown in FIG. 3D, the newly allocated memory nerve cell is the eleventh memory nerve cell, the activated memory nerve cells are the sixth memory nerve cell and the eleventh memory nerve cell, namely the total number new of the newly allocated memory nerve cells is 1, the total number active of the activated memory nerve cells is 2, and thus the anomaly score is 0.5.

In step 1062, when the anomaly score is greater than or equal to a preset anomaly threshold, the current metrical data is determined to be abnormal.

In the present disclosure, the anomaly threshold can be a value set by the user, or can also be a default experience value.

If the administrator of the anomaly monitoring system specially pays close attention to one or more abnormal conditions of the current metrical data, the time series corresponding to the one or more abnormal conditions can be recorded by a preset memory nerve cell. In this way, when the anomaly monitoring system detects that the activated memory nerve cells comprises the above-mentioned preset memory nerve cell, it can be determined that the current metrical data is abnormal.

In the above-mentioned technical solutions, the anomaly monitoring system records each time series in the time series set corresponding to the current metrical data through the memory nerve cell to form a memory nerve cell layer similar to a cerebral cortical nerve cell, and detects the anomaly of the current metrical data through the memory nerve cell layer. As a time series memory search mode is adopted in the anomaly detection, there is no need to mathematically fit the metrical data, therefore the anomaly monitoring system supports the anomaly detection of non-continuous metrical data to which the time series cannot be predicted, for example, it can be applied to the anomaly detection during magnetic disk read-write. Therefore, the adaptability of the anomaly monitoring system to different types of metrical data and complexly changing metrical data is higher. In addition, as the anomaly monitoring system can gradually reinforce the learning ability and the judging ability according to the gradually obtained metrical data, it does not need to learn large-scale historical data in advance, and thus the problem of cold start can be solved. Moreover, the larger the scale of the obtained metrical data is, the higher the learning ability and the judging ability of the anomaly monitoring system are, and the higher the accuracy of anomaly detection is.

FIG. 1D is a flowchart of a method for detecting anomalies in time series shown according to another exemplary embodiment. As shown in FIG. 1D, the above-mentioned method can further comprise the following steps.

In step 109, anomaly alarm is performed when determining that the current metrical data is abnormal.

In the present disclosure, the anomaly monitoring system can perform the anomaly alarm in at least one of the following manners when determining that the current metrical data is abnormal: displaying anomaly information, playing anomaly alarm voice, flickering an anomaly mark (for example, an indicator lamp, an icon and the like) corresponding to the current metrical data, sending a message to an administrator of the anomaly monitoring system, and so on, therefore the administrator of the anomaly monitoring system can discover the abnormal condition in time and take corresponding measures for the abnormal condition. In addition, for the abnormal condition the system administrator pays close attention to, the system can perform special anomaly alarm, for example, play specific anomaly alarm voice, accelerate the flickering frequency of the anomaly mark (for example, an indicator lamp, an icon and the like) corresponding to the current metrical data, etc.

FIG. 1E is a flowchart of a method for detecting anomalies in time series shown according to another exemplary embodiment. As shown in FIG. 1E, the above-mentioned method can further comprise the following steps.

In step 110, feedback information for the anomaly alarm input by the user is received.

In step 111, the anomaly threshold is adjusted according to the feedback information.

In the present disclosure, the anomaly threshold can be adjusted according to the feedback information for the anomaly alarm input by the system administrator. The feedback information can comprise ignoring or negating the anomaly alarm and processing the anomaly alarm. When the number of times of ignoring or negating the anomaly alarm by the system administrator exceeds a preset first time threshold, it indicates that the attention of the system administrator to the abnormal condition in time series corresponding to the anomaly alarm is lower or the anomaly alarm belongs to false alarm, at this time, the anomaly threshold can be increased to greatly reduce the false alarm rate of the anomaly alarm, and the adaptability of the method for detecting anomalies in time series is enhanced; when the number of times of processing the anomaly alarm by the system administrator exceeds a preset second time threshold, it indicates that the attention of the system administrator to the abnormal condition in time series corresponding to the anomaly alarm is higher, at this time, the anomaly threshold can be decreased to raise the attention of the system administrator to the abnormal condition in time series and enhance the sensitivity of the data anomaly detection so as to improve the safety of the anomaly monitoring system. In addition, it should be noted that the first time threshold and the second time threshold can be values set by the system administrator or default experience values, and the two time thresholds can be equal or not, which is not specifically defined therein.

FIG. 5 is a block diagram of an apparatus for detecting anomalies in time series shown according to an exemplary embodiment. With reference to FIG. 5, the apparatus 500 can comprise: a first obtaining module 501, used for obtaining current metrical data, wherein the current metrical data and historically obtained metrical data of the same type form a target time series; a second obtaining module 502, used for obtaining a time series set corresponding to the current metrical data obtained by the first obtaining module 501, wherein the time series set comprises at least one time series formed according to continuous metrical data from the n^{th} metrical data prior to the current metrical data to the current metrical data in the target time series, and n is a natural number; a judging module 503 used for: for each time series in the time series set obtained by the second obtaining module 502, judging whether a memory nerve cell used for recording the time series exists; an allocating module 504, used for allocating a memory nerve cell to the time series so as to record the time series when the judging module 503 judges the absence of the memory nerve cell, and activating the allocated memory nerve cell; an activating module 505, used for activating the memory nerve cell when the judging module 503 judges the existence of the memory nerve cell; and an anomaly determining module 506, used for determining whether the current metrical data obtained by the first obtaining module 501 is abnormal at least according to the activated memory nerve cells.

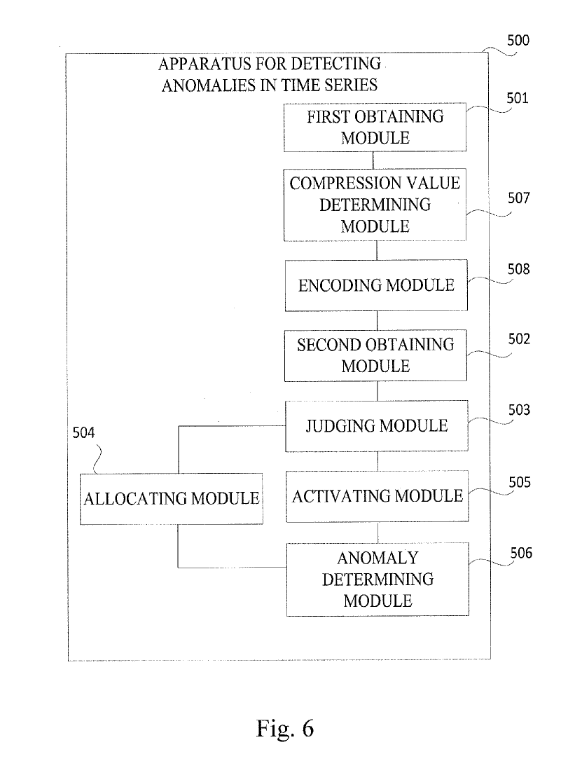

FIG. 6 is a block diagram of an apparatus for detecting anomalies in time series shown according to another exemplary embodiment. With reference to FIG. 6, the apparatus 500 can further comprise: a compression value determining module 507, used for determining a compression value corresponding to the current metrical data through the above formula (1) before the second obtaining module 502 obtains the time series set corresponding to the current metrical data; an encoding module 508, used for encoding the compression value determined by the compression value determining module 507 to obtain encoded data corresponding to the current metrical data obtained by the first obtaining module; and each time series in the time series set is a sequence composed of each encoded data respectively corresponding to each metrical data forming the time series.

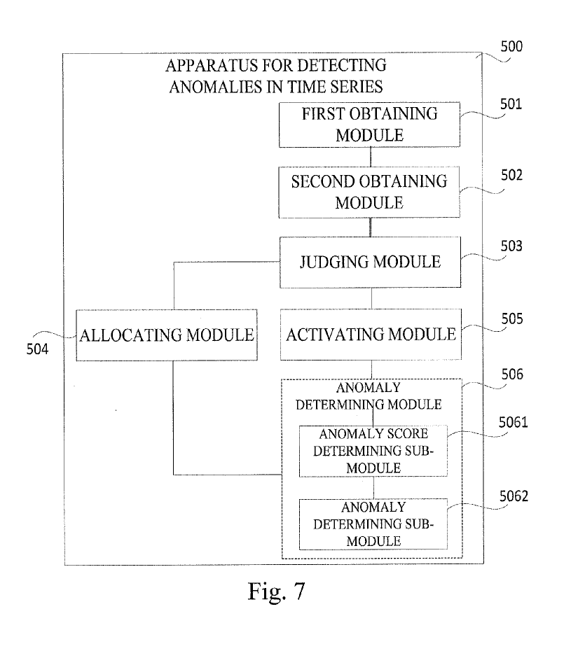

FIG. 7 is a block diagram of an apparatus for detecting anomalies in time series shown according to another exemplary embodiment. With reference to FIG. 7, the anomaly determining module 506 can comprise: an anomaly score determining sub-module 5061, used for determining an anomaly score according to the total number of the memory nerve cells newly allocated by the allocating module 504 and the total number of the activated memory nerve cells; and an anomaly determining sub-module 5062 used for: when the anomaly score determined by the anomaly score determining sub-module 5061 is greater than or equal to a preset anomaly threshold, determining that the current metrical data is abnormal.

Optionally, the anomaly score determining sub-module 5061 is used for determining the anomaly score according to the total number of the memory nerve cells newly allocated by the allocating module 504 and the total number of the activated memory nerve cells through the above formula (2).

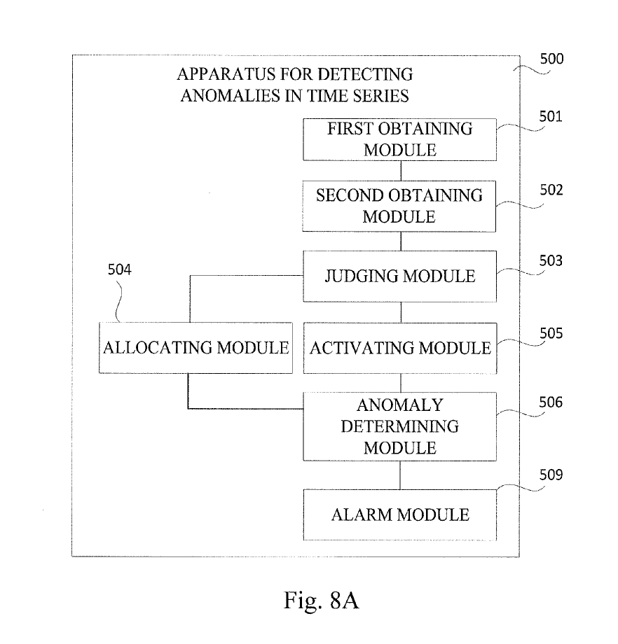

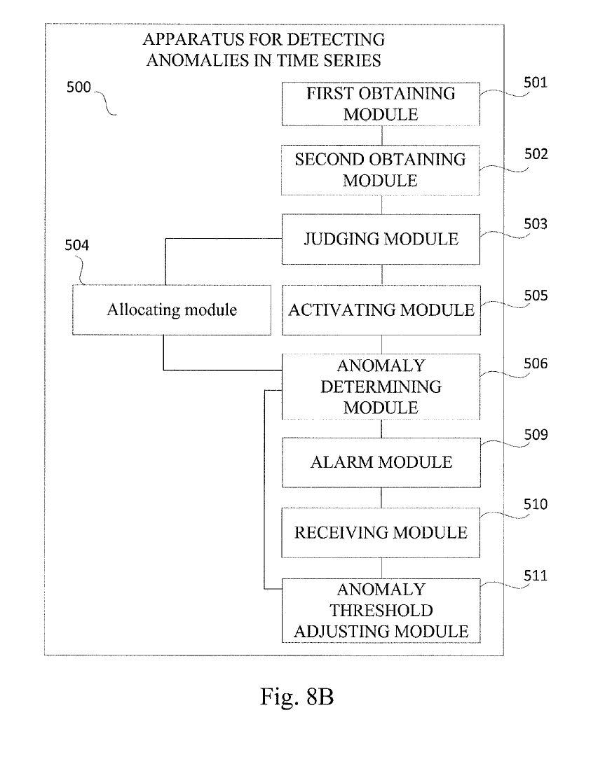

FIG. 8A is a block diagram of an apparatus for detecting anomalies in time series shown according to another exemplary embodiment. With reference to FIG. 8A, the apparatus 500 can further comprise: an alarm module 509, used for performing anomaly alarm when the anomaly determining module 506 determines that the current metrical data is abnormal.

FIG. 8B is a block diagram of an apparatus for detecting anomalies in time series shown according to another exemplary embodiment. With reference to FIG. 8B, the apparatus 500 can further comprise: a receiving module 510, used for receiving feedback information for the anomaly alarm issued by the alarm module 509 input by a user; and an anomaly threshold adjusting module 511, used for adjusting the anomaly threshold according to the feedback information received by the receiving module 510.

Optionally, the anomaly determining module 506 is used for determining that the current metrical data obtained by the first obtaining module 501 is abnormal when the activated memory nerve cells comprises a preset memory nerve cell.

Optionally, the allocating module 504 comprises at least one of the following sub-modules: a first allocating sub-module, used for allocating a new memory nerve cell to the time series so as to record the time series when the judging module 503 judges the absence of the memory nerve cell and when the total number of the activated memory nerve cells is smaller than a predetermined number, and activating the allocated new memory nerve cell; and a second allocating sub-module, used for reallocating the memory nerve cell having the least activation time in the activated memory nerve cells to the time series so as to record the time series when the judging module 503 judges the absence of the memory nerve cell and when the total number of the activated memory nerve cells is greater than or equal to the predetermined number, and activating the allocated memory nerve cell.

With respect to the apparatus in the above-mentioned embodiment, the specific modes of the modules to execute operations have been described in the embodiments related to the method in detail, and thus will not be illustrated herein in detail.

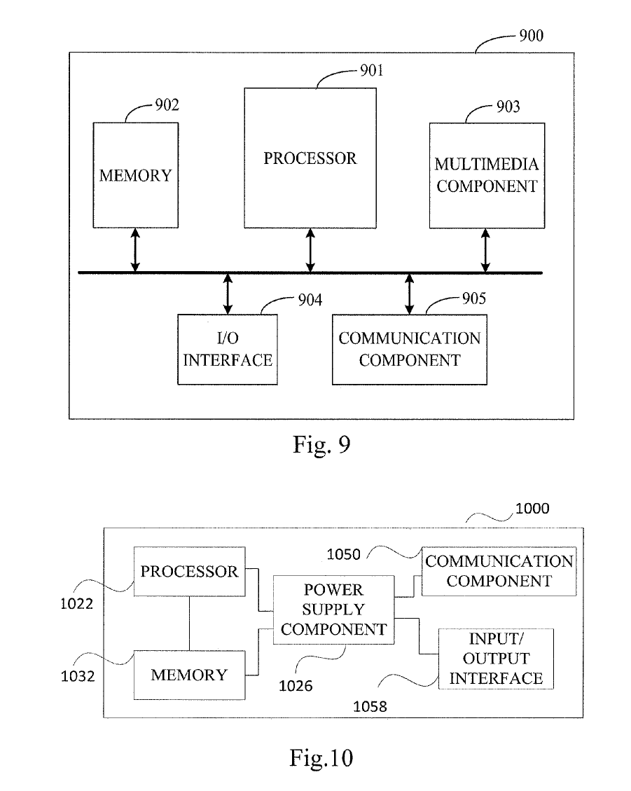

FIG. 9 is a block diagram of an electronic device 900 shown according to an exemplary embodiment. As shown in FIG. 9, the electronic device 900 can comprise: a processor 901, a memory 902, a multimedia component 903, an input/output (I/O) interface 904 and a communication component 905.

The processor 901 is used for controlling the overall operation of the electronic device 900 so as to accomplish all or a part of steps in the above-mentioned method for detecting anomalies in time series. The memory 902 is used for storing data of various types to support the operations in the electronic device 900, for example, these data can comprise instructions used for operating any application program or method on the electronic device 900 and data related to the application program, for example, contact data, received and sent messages, pictures, audios, videos, and so on. The memory 902 can be realized by any type of volatile or nonvolatile memory devices or combinations thereof, for example, a static random access memory (referred to as SRAM), electrically erasable programmable read-only memory (referred to as EEPROM), erasable programmable read-only memory (referred to as EPROM), a programmable read-only memory (referred to as PROM), a read-only memory (referred to as ROM), a magnetic memory, a flash memory, a magnetic disk or an optical disk. The multimedia component 903 can comprise a screen and an audio component. For example, the screen can be a touch screen, and the audio component is used for outputting and/or inputting audio signals. For example, the audio component can comprise a microphone, and the microphone is used for receiving external audio signals. The received audio signals can be further stored in the memory 902 or sent by the communication component 905. The audio component further comprises at least one loudspeaker used for outputting the audio signals. The I/O interface 904 provides an interface between the processor 901 and other interface modules, and the other interface modules can be a keyboard, a mouse, buttons and the like. These buttons can be virtual buttons or physical buttons. The communication component 905 is applied to the wired or wireless communication between the electronic device 900 and other devices. For example, the wireless communication comprises Wi-Fi, Bluetooth, near field communication (referred to as NFC), 2G, 3G, or 4G, or the combination of one or more thereof, therefore the corresponding communication component 905 can comprise: a Wi-Fi module, a Bluetooth module and an NFC module.

In an exemplary embodiment, the electronic device 900 can be implemented by one or more application specific integrated circuits (referred to as ASIC), digital signal processors (referred to as DSP), digital signal processing devices (referred to as DSPD), programmable logic devices (referred to as PLD), field programmable gate arrays (referred to as FPGA), controllers, microcontrollers, microprocessors or other electronic components, in order to execute the above-mentioned method for detecting anomalies in time series.

In another exemplary embodiment, a computer readable storage medium comprising a program instruction is further provided, for example, the memory 902 comprising the program instruction, and the program instruction can be executed by the processor 901 of the electronic device 900 so as to accomplish the above-mentioned method for detecting anomalies in time series.

FIG. 10 is a block diagram of an electronic device 1000 shown according to another exemplary embodiment. For example, the electronic device 1000 can be provided as a server. With reference to FIG. 10, the electronic device 1000 comprises one or more processors 1022, and a memory 1032 used for storing a computer program that can be executed by the processor 1022. The computer program stored in the memory 1032 can comprise one or more modules each of which corresponds to a group of instructions. In addition, the processor 1022 can be configured to execute the computer program to execute the above-mentioned method for detecting anomalies in time series.

In addition, the electronic device 1000 can comprise a power supply component 1026 and a communication component 1050, wherein the power supply component 1026 can be configured to execute the power supply management of the electronic device 1000, and the communication component 1050 can be configured to realize the communication of the electronic device 1000, for example, wired or wireless communication. In addition, the electronic device 1000 can further comprise an input/output (I/O) interface 1058. The electronic device 1000 can operate an operating system stored in the memory 1032, for example, Windows Server™, Mac OS X™, Unix™, Linux™, etc.

In another exemplary embodiment, a computer readable storage medium comprising a program instruction is further provided, for example, the memory 1032 comprising the program instruction, and the program instruction can be executed by the processor 1022 of the electronic device 1000 so as to accomplish the above-mentioned method for detecting anomalies in time series.

Preferred implementations of the present disclosure have been described above in detail in combination with the drawings, however, the present disclosure is not limited to the specific details in the above-described implementations, various simple modifications may be made to the technical solutions of the present disclosure within the scope of the technical concept of the present disclosure, and these simple modifications all fall within the protection scope of the present disclosure.

It should also be noted that the specific technical features described in the specific implementations described above may be combined in any appropriate manner without contradiction. In order to avoid unnecessary duplication, the present disclosure does not additionally illustrate various possible combinations.

In addition, various different implementations of the present disclosure may also be randomly combined without departing from the idea of the present disclosure, and the combinations should likewise be regarded as the contents disclosed by the present disclosure.

1. A method for detecting anomalies in time series, comprising:
obtaining current metrical data, wherein the current metrical data and historically obtained metrical data of the same type form a target time series;
obtaining a time series set corresponding to the current metrical data, wherein the time series set comprises at least one time series formed according to continuous metrical data from the n^{th} metrical data prior to the current metrical data to the current metrical data in the target time series, and n is a natural number;
for each time series in the time series set, judging whether a memory nerve cell used for recording the time series exists;
activating the memory nerve cell when the existence of the memory nerve cell is judged;
allocating a memory nerve cell to the time series so as to record the time series when the absence of the memory nerve cell is judged, and activating the allocated memory nerve cell; and
determining whether the current metrical data is abnormal at least according to the activated memory nerve cells.

2. The method of claim 1, wherein prior to the step of obtaining a time series set corresponding to the current metrical data, the method further comprises:
determining a compression value corresponding to the current metrical data through the following formula:
$${v}^{′} = max ( ⌊ \frac{v - {v}_{min}}{{v}_{max} - {v}_{min}} \times M ⌋ , 0 )$$
wherein, v′ represents the compression value, v represents the current metrical data; vₘᵢₙ represents the minimum value in the target time series; vₘₐₓ represents the maximum value in the target time series; M represents the number of parts into which the data interval between the minimum value and the maximum value is equally divided;
encoding the compression value to obtain encoded data corresponding to the current metrical data; and
wherein each time series in the time series set is a sequence composed of each encoded data respectively corresponding to each metrical data forming the time series.

3. The method of claim 1, wherein the determining whether the current metrical data is abnormal at least according to the activated memory nerve cells comprises:
determining an anomaly score according to the total number of the newly allocated memory nerve cells and the total number of the activated memory nerve cells; and
when the anomaly score is greater than or equal to a preset anomaly threshold, determining that the current metrical data is abnormal.

4. The method of claim 3, wherein the determining an anomaly score according to the total number of the newly allocated memory nerve cells and the total number of the activated memory nerve cells comprises:
determining the anomaly score according to the total number of the newly allocated memory nerve cells and the total number of the activated memory nerve cells through the following formula:
$$score = \frac{new}{active}$$
wherein, score represents the anomaly score; new represents the total number of the newly allocated memory nerve cells; and active represents the total number of the activated memory nerve cells.

5. The method of claim 3, further comprising:
performing anomaly alarm when determining that the current metrical data is abnormal;
receiving feedback information for the anomaly alarm input by a user; and
adjusting the anomaly threshold according to the feedback information.

6. The method of claim 1, wherein the determining whether the target time series is abnormal at least according to the activated memory nerve cells comprises:
determining that the current metrical data is abnormal when the activated memory nerve cells comprises a preset memory nerve cell.

7. The method of claim 1, wherein the allocating a memory nerve cell to the time series so as to record the time series when the absence of the memory nerve cell is judged, and activating the allocated memory nerve cell comprises at least one of the following steps:
allocating a new memory nerve cell to the time series so as to record the time series when the absence of the memory nerve cell is judged and when the total number of the activated memory nerve cells is smaller than a predetermined number, and activating the allocated new memory nerve cell; and
reallocating the memory nerve cell having the least activation time in the activated memory nerve cells to the time series so as to record the time series when the absence of the memory nerve cell is judged and when the total number of the activated memory nerve cells is greater than or equal to the predetermined number, and activating the allocated memory nerve cell.

8. The method of claim 1, further comprising: performing anomaly alarm when determining that the current metrical data is abnormal.

9. A computer readable storage medium with a computer program stored thereon, wherein the program realizes method comprising the following steps:
obtaining current metrical data, wherein the current metrical data and historically obtained metrical data of the same type form a target time series;
obtaining a time series set corresponding to the current metrical data, wherein the time series set comprises at least one time series formed according to continuous metrical data from the n^{th} metrical data prior to the current metrical data to the current metrical data in the target time series, and n is a natural number;
for each time series in the time series set, judging whether a memory nerve cell used for recording the time series exists;
activating the memory nerve cell when the existence of the memory nerve cell is judged;
allocating a memory nerve cell to the time series so as to record the time series when the absence of the memory nerve cell is judged, and activating the allocated memory nerve cell; and
determining whether the current metrical data is abnormal at least according to the activated memory nerve cells.

10. An electronic device, comprising:
the computer readable storage medium of claim 9; and
one or more processors, used for executing the program in the computer readable storage medium.
